(19) United States
(12) Patent Application Publication
(10) Pub. No.: US 2011/0054709 A1
(43) Pub. Date: Mar. 3, 2011

(54) POWER DISTRIBUTION METHOD AND NETWORK TOPOLOGY METHOD FOR SMART GRID MANAGEMENT, AND APPARATUS THEREFOR

(75) Inventor: Myung-Hee SON, Daejeon (KR)

(73) Assignee: Electronics and Telecommunications Research Institute, Daejeon (KR)

(21) Appl. No.: 12/868,044

(22) Filed: Aug. 25, 2010

(30) Foreign Application Priority Data
Aug. 26, 2009 (KR) 10-2009-0079463
May 18, 2010 (KR) 10-2010-0046492

(51) Int. Cl. G06F 19/00

(52) U.S. Cl. 700/286

(57) ABSTRACT

Provided is a power distribution apparatus that includes: a neighboring node information collection unit collecting power distribution amount information and physical distance information between grid nodes from neighboring grid nodes belonging to the same grid network; and a power transmission target node selecting unit allocating priorities to the neighboring grid nodes by using the power distribution amount information and the distance information and selecting a neighboring grid node having the highest priority as a neighboring power transmission grid node by comparing the priorities allocated to the neighboring grid nodes.

### CROSS REFERENCE TO RELATED APPLICATIONS

This application claims priority to Korean Patent Application No. 10-2009-0079463 filed on Aug. 26, 2009 and Korean Patent Application No. 10-2010-0046492 filed on May 18, 2010, the entire contents of which are herein incorporated by reference.

### BACKGROUND OF THE INVENTION

1. Field of the Invention

The present invention relates to a power distribution method and a network topology method for smart grid management, and an apparatus therefore. More particularly, the present invention relates to a power distribution method and a network topology method capable of efficiently managing a smart grid while minimizing waste of electric power transmitted to general homes from a generator through a power distributor.

2. Description of the Related Art

A smart grid as a next-generation electric power network system improves the efficiency of a system by grafting a telecommunication technology onto the existing processes of production, transport, and consumption of electric power. An electric power supplier and a consumer interoperate with each other to improve the efficiency of the system.

First of all, a current electric power system should be understood in order to describe the smart grid. Generally, the amount of electricity used by consumers is designed to be produced more than what is actually used by approximately 10%. The amount of electrical power consumed and electricity usage is at the maximum allowance, this means, in advance, prevents using more than allowed. Therefore, various power generation facilities are additionally required in addition to fuel. However, an amount of wasted electricity is also large, as a result, energy efficiency is deteriorated. Further, an amount of discharged carbon dioxide at the time of burning coal, oil, gas, and the like is increased.

When the electricity can be produced as needed or can be used depending on the production, it is possible to prevent global warming while more efficiently using the electricity. This is the reason why a smart grid capable of detecting consumption and supply of electricity, and a condition of a power line by fusing an IT technology with a smart grid attracts public attention.

A predetermined U.S. weekly economic magazine has already introduced the smart grid as one of countermeasures for rescuing the human from unforeseen weather phenomena and environmental pollutions that are caused by the global warming.

When the smart grid is literally analyzed, the core of the smart grid is in that a consumer and an electric power company send and receive information to and from each other by fusing the IT technology with the smart grid. By using such a system, the consumer can consume electricity when electric charges are at a low rate, for example, electronic apparatuses can automatically operate when the electricity charges are at a low rate.

Consequently, the smart grid is a new concept system that integrally and effectively manages all components on which electricity flows, which include industrial equipment that operate in a factory as well as electronic apparatuses such as a TV, a refrigerator, and the like that are used in a general home.

However, in the smart grid that is currently being introduced, a network topology related to smart grid management is not considered in detail and as a result, the smart grid is vulnerable in terms of extensibility, operability, and security of the smart grid.

### SUMMARY OF THE INVENTION

The present invention has been made in an effort to provide a method which can improve power distribution efficiency by defining a network topology configuration among apparatuses constituting a smart grid in order to increase the extensibility, flexibility, and security of a smart grid management and efficiently managing a smart grid through the defined network topology configuration, and a power distribution apparatus.

An exemplary embodiment of the present invention provides a network topology and power distribution method for smart grid management that include: receiving, by a predetermined grid node, power distribution amount information and physical distance information between grid nodes from neighboring grid nodes belonging to the same grid network; allocating, by a predetermined grid node, priorities to the neighboring grid nodes by using the power distribution amount information and the distance information; and selecting, by a predetermined grid node, a neighboring grid node having the highest priority as a neighboring power target transmission grid node by comparing the priorities allocated to the neighboring grid nodes.

In particular, the receiving power distribution amount information and physical distance information between grid nodes from neighboring grid nodes belonging to the same grid network is performed when a predetermined neighboring power transmission target grid node loses its function while the predetermined grid node transmits electric power to the predetermined neighboring power transmission target grid node depending on an initially set route.

Further, the predetermined grid node determines whether or not the neighboring power transmission target grid node loses its function by using a status verification message (Hello message) received from the neighboring power transmission target grid node.

In addition, the allocating priorities to the neighboring grid nodes by using the power distribution amount information and the distance information allocates the higher priority to a grid node having the larger power distribution amount by comparing the power distribution amount information of the neighboring grid nodes with each other.

Moreover, when a plurality of neighboring grid nodes have the same power distribution amount, the higher priority is allocated to a grid node which is closer to the predetermined grid node by comparing the physical distance information of the neighboring grid nodes with each other.

The method further includes, blocking the transmission of electric power to other neighboring grid nodes other than the selected neighboring power transmission target grid node, when the neighboring power transmission target grid node is selected.

The predetermined grid node is a root grid node or a relay grid node.

The neighboring power transmission target grid node is any one of the relay grid node, a leaf grid node, and a hybrid grid node.

The hybrid grid node is connected with one or more power consumers that both produce and consume electric power.

Another exemplary embodiment of the present invention provides a network topology and power distribution method for smart grid management that includes: receiving, by a root grid node belonging to a predetermined grid network, power generation amount information in a neighboring grid network from a root grid node of the neighboring grid network belonging to the same smart grid; determining, by a root grid node belonging to a predetermined grid network, whether a neighboring gird network, having a larger power generation amount than that in the predetermined grid network exists; calculating, by a root grid node belonging to a predetermined grid network, a total power generation amount in the smart grid by using the power generation amount information received from the root grid node belonging to the neighboring grid network when the neighboring gird network having a larger power generation amount than that in the predetermined grid network does not exist; and transmitting, by a root grid node belonging to a predetermined grid network, information on the total power generation amount to a generator.

In particular, the root grid node belonging to the predetermined grid network is connected with a root grid node belonging to each of a plurality of neighboring grid networks in a mesh structure to configure one smart grid.

Further, the predetermined grid network includes a root grid node, a relay grid node, a leaf grid node, and a hybrid grid node, and each of the grid nodes belonging to the predetermined grid network is connected with other grid nodes in the mesh structure.

In addition, the root grid node is directly connected with a power transmitter to distribute electricity supplied from the power transmitter to the relay grid node.

Moreover, the hybrid grid node is connected with one or more power consumers that both produce and consume electric power and transmits information on a power production amount and information on power consumption of the power consumer to the relay grid node.

Besides, the relay grid node transmits the information on the power production amount and the information on the power consumption of the power consumer received from the hybrid grid node to the root grid node.

The relay grid node relays power distribution between the root grid node and the leaf grid node or relays power distribution between the root grid node and the hybrid grid node.

Yet another exemplary embodiment of the present invention a network configuration and power distribution apparatus for smart grid management that includes: a neighboring node information collection unit collecting power distribution amount information and physical distance information between grid nodes from neighboring grid nodes belonging to the same grid network; and a power transmission target node selecting unit allocating priorities to the neighboring grid nodes by using the power distribution amount information and the distance information and selecting a neighboring grid node having the highest priority as a neighboring power transmission grid node by comparing the priorities allocated to the neighboring grid nodes.

Further, the power transmission target node selecting unit allocates the higher priority to a grid node having the larger power distribution amount by comparing the power distribution amount information of the neighboring grid nodes with each other and when a plurality of neighboring grid nodes have the same power distribution amount, allocates the higher priority to a grid node which is closer to the predetermined grid node by comparing the physical distance information of the neighboring grid nodes with each other.

In addition, the apparatus further includes, when the neighboring power transmission target grid node is selected by the power transmission target node selecting unit, a connection blocking unit blocking the transmission of electric power to other neighboring grid nodes other than the selected neighboring power transmission target grid node.

Moreover, the neighboring power transmission target grid node is any one of a relay grid node, a leaf grid node, and a hybrid grid node.

According to the exemplary embodiments of the present invention, the following effects can be acquired.

It is possible to improve the extensibility, flexibility, and security of smart grid management through a network topology configuration between devices constituting the smart grid.

Further, since a power producer can determine an electric power production status and an electric power usage status of the power consumer through the defined network topology configuration, the power producer can flexibly adjust the electric power supply amount. In addition, it is possible to perform flexible management in which electricity is stored and thereafter, is supplied in a time zone in which power consumption is large and to prevent a failure of the smart grid caused due to an overload.

### BRIEF DESCRIPTION OF THE DRAWINGS

FIG. 1 is a diagram referenced for describing a network topology of a smart grid according to an exemplary embodiment of the present invention;

FIG. 2 is a diagram illustrating an example for describing a network topology for smart grid management according to an exemplary embodiment of the present invention;

FIG. 3 is a flowchart for describing a process of determining a priority among grid nodes;

FIG. 4 is a block diagram for describing a configuration of a power distribution apparatus according to an exemplary embodiment of the present invention;

FIG. 5 is a flowchart for describing a process of selecting a representative root grid node in a smart grid and a process for the selected representative root grid node to transmit information on a power generation capacity in the smart grid to a generator; and

FIG. 6 is a flowchart for describing a process for a predetermined grid node in a grid network to select an alternative grid node when a neighboring power transmission target grid node loses its function.

### DETAILED DESCRIPTION OF THE PREFERRED EMBODIMENTS

The present invention will be described below with reference to the accompanying drawings. Herein, the detailed description of a known function and configuration that may make the purpose of the present invention unnecessarily ambiguous in describing the spirit of the present invention will be omitted. Exemplary embodiments of the present invention are provided so that those skilled in the art may more completely understand the present invention. Accordingly, the shape, the size, etc., of elements in the figures may be exaggerated for explicit comprehension.

Detailed means and exemplary embodiments of the present invention will be described with reference to the accompanying drawings for describing the present invention in detail.

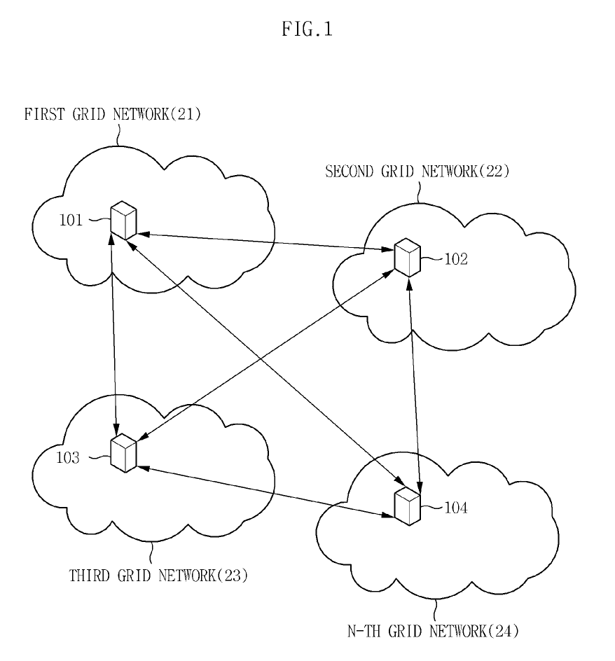

FIG. 1 is a diagram referenced for describing a network topology of a smart grid according to an exemplary embodiment of the present invention.

Referring to FIG. 1, the smart grid includes a plurality of grid networks 21, 22, 23, and 24 and the grid networks may be divided for each power distribution unit. For example, the first grid network 21 may be connected to electric power consumers (alternately electric power consuming households) such as a house and the second grid network 22 may be connected to electric power consumers such as a company, and the third grid network 23 may be connected to electric power consumers such as a factory.

The grid networks 21, 22, 23, and 24 are connected with other grid networks through representative power distributors 101, 102, 103, and 104 that exist in the network in a mesh structure to constitute one large-scale smart grid. For example, the first grid network 21 is directly connected with the second grid network 22, the third grid network 23, and the fourth grid network 24 through the representative power distributor 101.

The smart grid receives electricity from one generator. Each of the representative power distributors 101, 102, 103, and 104 is directly connected with a power transmitter to receive the electricity from the power transmitter. In addition, each of the representative power distributors 101, 102, 103, and 104 transmits the electricity received from the power transmitter to the power consumer through the corresponding grid network.

Meanwhile, the smart grid constituted by four grid networks is shown in FIG. 1 to help understanding the present invention, but the number of the network grids may depend on the number of power consumers, the power consumption, and the like and in addition, the scale of each grid network may dynamically be changed depending on a construction environment of the network.

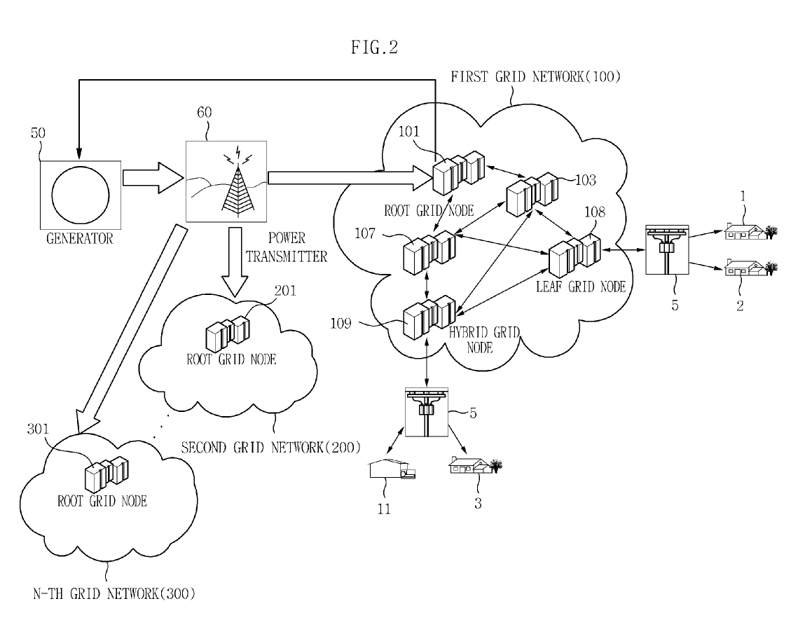

FIG. 2 is a diagram illustrating an example for describing a network topology for smart grid management according to an exemplary embodiment of the present invention.

Referring to FIG. 2, electricity produced by the generator 50 is transmitted to the power transmitter 60 through a transmission medium such as a power line cable, the power transmitter 60 distributes the electricity received from the generator 50 to each of the representative power distributors 101, 201, and 301 of each of the grid networks 100, 200, and 300 connected with the transmitter 60 itself so as to supply electric power to power consumers 1, 2, 3, and 11 connected to the grid networks.

Hereinafter, in order to prevent a duplicate description, configurations of other grid networks according to an exemplary embodiment of the present invention will be described by using the first grid network 100 as an example.

The first grid network 100 is constituted by a plurality of grid nodes (power distributors). The grid nodes belonging to the first grid network 100 are connected with other grid nodes in the mesh structure.

Herein, a grid node (that is, a representative power distributor) directly connected with the power transmitter 60 is referred to as a root grid node 101, a grid node connected with only the power consumers 1 and 2 who merely consume electric power without generating electric power is referred to as a leaf grid node 108, and a grid node connected with the power consumer 11 who both generates and consumes the electric power in addition to the power consumer 3 who merely consumes the electric power is referred to as a hybrid grid node 109. In addition, a grid node that relays power distribution between the root grid node 101 and the leaf grid node 108 or between the root grid node 101 and the hybrid grid node 109 will be referred to as relay grid nodes 103 and 107.

The root grid node 101 that receives the electricity from the power transmitter 60 distributes electric power to the relay grid nodes 103 and 107. The relay grid nodes 103 and 107 connected with the root grid node 101 distribute electric power to other relay grid node, the hybrid grid node 109, or the leaf grid node 108. Of course, depending on the construction environment, the root grid node 101 may be directly connected with the hybrid grid node 109 or the leaf grid node 108.

The final power consumers 1, 2, 3, and 11 receive electric power from the leaf grid node 108 or the hybrid grid node 109 through a transformer 5.

Each of the grid nodes 101, 103, 107, 108, and 109 transmits information (e.g., power distribution amount) on its own power distribution status to neighboring grid nodes to allow grid nodes belonging in the same grid network 100 to determine power distribution statuses of grid nodes adjacent to themselves and an overall power distribution status of the corresponding grid network 100.

In particular, the hybrid node 109 and the leaf grid node 108 transmit information (e.g., power consumption amount, etc.) on power consumption statuses of the power consumers 1, 2, 3, and 11 connected therewith and information (e.g., power generation amount, etc.) on their generation statuses to neighboring grid nodes to allow the grid nodes belonging to the same grid network 100 to determine an overall power consumption status and generation status of the corresponding grid network 100.

According to the exemplary embodiment of the present invention having such a network configuration, when a predetermined grid node does not operate, a grid node connected to the predetermined grid node may easily divert electricity onto an alternative route and efficiently distribute electric power among grid nodes in a grid network by monitoring power consumption of consumers in real time.

Further, when the power consumer who both consumes and generates electric power is connected to a predetermined network, electricity produced in the corresponding grid network is easily received by an adjacent grid network so as to efficiently distribute electricity between the grid networks or the grid nodes.

Further, the root grid node feeds back a power generation amount generatable in each grid network to the generator, which can control the power generation amount depending on the circumstances so as to save energy and reduce carbon dioxide.

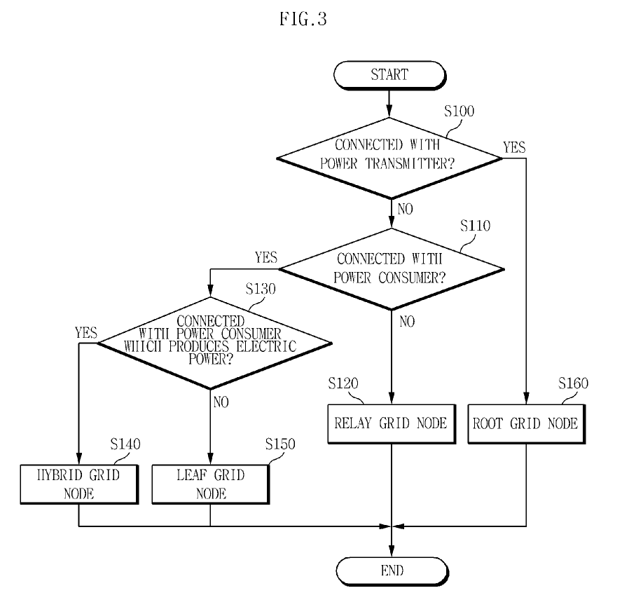

FIG. 3 is a flowchart for describing a process of determining a priority among grid nodes.

Referring to FIG. 3, it is determined whether or not a predetermined grid node (hereinafter, referred to as “grid node A”) that exists or participates in a smart grid according to an exemplary embodiment of the present invention is connected with a power transmitter (S100).

According to the determination result at step S100, when grid node A is connected with the power transmitter, grid node A serves as a root grid node.

However, according to the determination result at step S100, when grid node A is not connected with the power transmitter, it is determined that grid node A is connected to a power consumer (S110).

According to the determination result at step S110, when grid node A is connected with the power consumer, it is determined whether or not the connected power consumer is a power consumer that can generate electric power. That is, it is determined whether or not the connected power consumer is a power consumer who consumes electric power supplied from a generator while producing electric power through its own power production apparatus (e.g., a solar generator, etc.) (S130).

According to the determination result at step S130, when grid node A is connected to a power consumer who both consumes and generates electric power, grid node A serves as a hybrid grid node and otherwise, grid node A serves as a leaf grid node.

A priority among grid nodes belonging to the same grid network is determined through the above-mentioned method and the determined priority of the grid node may be used as an address in the grid network. In order to determine a tree for final power distribution to the power consumer in a grid network having a mesh structure, a priority for determining levels among the grid nodes is required. Therefore, in the exemplary embodiment of the present invention, the priority value itself determined through the above-mentioned method is used as the address or a value acquired by concatenating the priority value with a basic network address of each grid node is used as the address (e.g., network address|priority value).

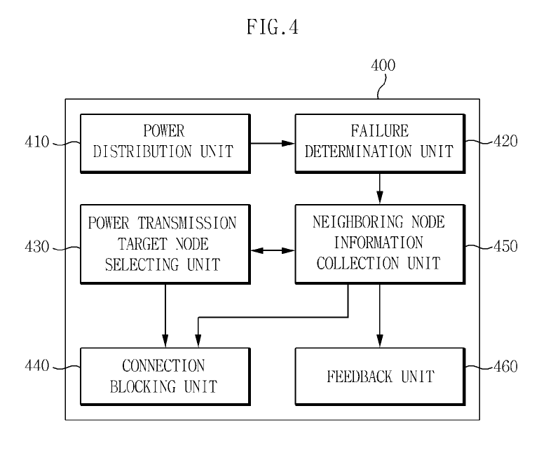

FIG. 4 is a block diagram for describing a configuration of a power distribution apparatus according to an exemplary embodiment of the present invention. Herein, the power distribution device may correspond to any one of the root grid node, the relay grid node, the leaf grid node, and the hybrid grid node.

Referring to FIG. 4, the power distribution apparatus 400 for smart grid management according to an exemplary embodiment of the present invention includes a power distribution unit 410, a failure determination unit 420, a power transmission target node selecting unit 430, a connection blocking unit 440, a neighboring node information collection unit 450, and a feedback unit 460.

The power distribution unit 410 distributes electricity supplied from a distributing device (grid node) of a neighboring or upper level to a neighboring power distribution device or a lower-level power distribution device in accordance with an initially set power transmission route.

The failure determination unit 420 determines whether or not a neighboring power transmission target grid node that exists on the set power transmission route loses its function and when the neighboring power transmission target grid node loses its function, the failure determination unit 420 delivers a message indicating that the power transmission target grid node loses its function to the neighboring node information collection unit 450. In this case, a method of determining whether or not the neighboring grid node is false or loses its function in the failure determination unit 420 is not limited to a predetermined method.

The neighboring node information collection unit 450 collects information on power distribution status from neighboring grid nodes belonging to the same grid network, information on a power generation status in the grid network, information on a physical distance between nodes, and information on a physical distance from a generator.

Further, the neighboring node information collection unit 450 collects information on a power generation amount in a neighboring grid network that belongs to the same electric power network and transmits the collected information to the feedback unit 460.

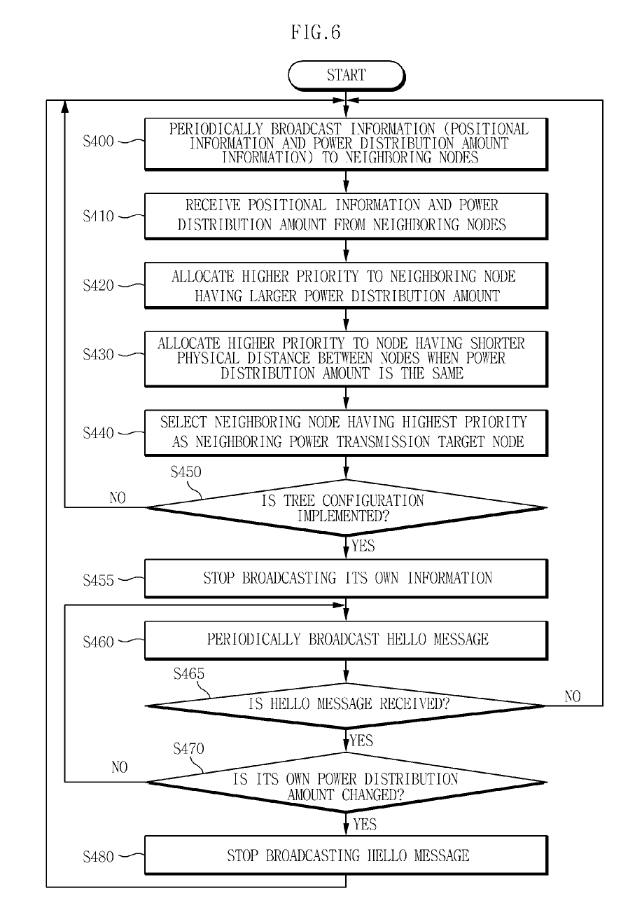

The power transmission target node selecting unit 430 selects a new power transmission target grid node on the basis of the information collected through the neighboring node information collection unit 450 when the power transmission target grid node loses its function. A process of selecting the new power transmission target grid node in the power transmission target node selecting unit 430 will be described in detail with reference to FIG. 6.

The connection blocking unit 440 virtually blocks transmission of electric power to other neighboring grid nodes other than the power transmission target grid node selected by the power transmission target node selecting unit 430.

The feedback unit 460 determines whether or not the power distribution apparatus 400 may be a representative root grid node in the corresponding smart grid by using the information collected through the neighboring node information collection unit 450. When the feedback unit 460 determines that the power distribution apparatus 400 is the representative root grid node, the feedback unit 460 feeds back information on a total power generation amount of the corresponding smart grid to the generator.

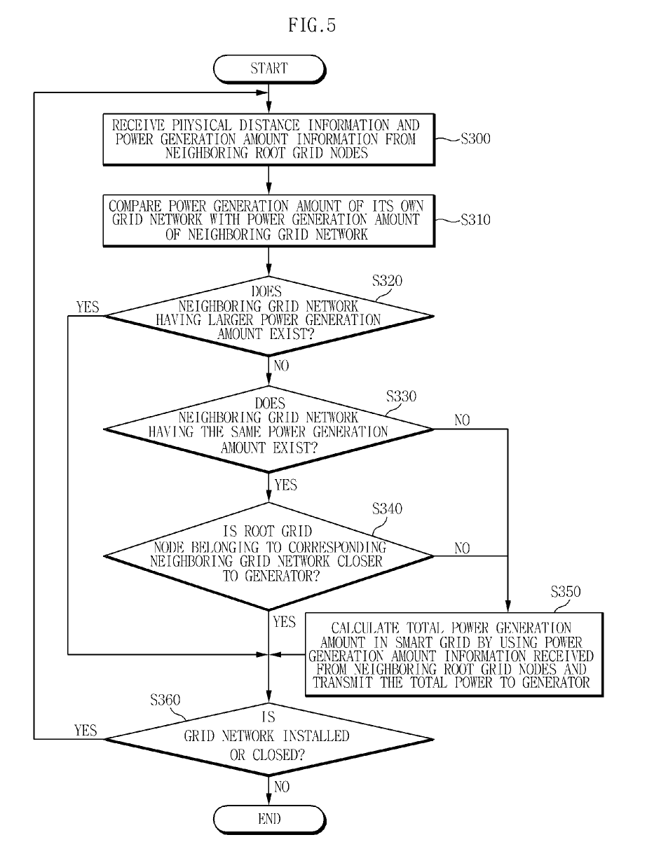

FIG. 5 is a flowchart for describing a process of selecting a representative root grid node in a smart grid and a process for the selected representative root grid node to transmit information on the capacity of power generation in the smart grid to a generator according to an exemplary embodiment of the present invention.

Referring to FIG. 5, a root grid node (hereinafter, referred to as “root grid node A”) that belongs to a predetermined grid network in the smart grid receives information on a physical distance and information on a power generation amount from root grid nodes of neighboring grid networks that belong to the same grid network (S300). In this case, the physical distance information which root grid node A receives from the neighboring root grid node represents information on a distance between the corresponding neighboring root grid node and the generator and the power generation amount information represents information on a power generation amount in a grid network to which the corresponding neighboring root grid node belongs.

For example, when a distance between root grid node B adjacent to root grid node A and the generator is 2 km and a power generation amount in grid network B to which neighboring root grid node B belongs is 9000 khw, neighboring root grid node B transmits the distance information (2 km) and the power generation amount information (9000 khw) to root grid node A. A power generation amount in a predetermined grid network may be increased as power consumers connected to the corresponding grid network, who can produce more electric power are more.

Next, root grid node A compares the power generation amount information in the grid network (hereinafter, referred to as “grid network A”) to which root grid node A itself belongs with the power generation information received from the neighboring grid nodes (S310) to determine whether a neighboring grid network that produces more electric power amount than grid network A is provided (S320).

According to the determination result at step S320, when the neighboring grid network that produce more power generation amount than the power generation amount of grid network A is provided, root grid node A cannot be the representative root grid node. However, root grid node A proceeds to step S360 before terminating the process to verify whether or not the existing grid network is closed and when the existing grid network is closed, root grid node A proceeds to step S300 to verify whether or not root grid node A can be the root grid node one more time. The verification at step S360 is to verify whether or not root grid node A can be the representative root grid node by the closing of the grid network one more time.

According to the determination result at step S320, when the neighboring grid network that produce more power generation amount than the power generation amount of grid network A is not provided, root grid node A proceeds to step S350 to serve as the representative root grid node. That is, root grid node A selected as the representative root grid node computes a total power generation amount in the corresponding smart grid by using the power generation amount information received from the neighboring root grid nodes in the same smart grid and transmits the computed power generation amount to the generator by using a predetermined communication interface (e.g., an Internet network, a mobile communication network, and the like). Accordingly, since the generator may determine a power production status of a power consumer in real time on the basis of the power generation amount information transmitted from the representative root grid node, the generator may flexibly adjust an electric power supply amount.

Meanwhile, according to the determination result at step S320, even when the neighboring grid network that produces more electric power than the power generation amount of grid network A is not provided, when a neighboring grid network having the same power generation amount is provided, root grid node A uses the physical distance from the generator as a parameter for next comparison. That is, it is determined whether or not a distance from a generator of a root grid node belonging to the corresponding neighboring grid network is shorter than a distance between root grid node A and the generator (that is, closer to the generator) (S330 and S340).

According to the determination result at step S304, when the root grid belonging to the corresponding neighboring grid network is closer to the generator, root grid node A cannot be the representative root grid node. However, root grid node A proceeds to step S360 before terminating the process to verify whether or not the existing grid network is closed and when the existing grid network is closed, root grid node A proceeds to step S300 to verify whether or not root grid node A can be the root grid node one more time.

However, according to the determination result at step S304, when root grid node A is closer to the generator, root grid node A proceeds to step S350 to serve as the representative root grid node. That is, root grid node A selected as the representative root grid node computes a total power generation amount in the corresponding smart grid by using the power generation amount received from the neighboring root grid nodes and transmits the computed power generation amount to the generator by using a predetermined communication interface (e.g., an Internet network, a mobile communication network, and the like).

According to the exemplary embodiment of the present invention, it is possible to improve the extensibility, flexibility, and security of smart grid management through a network topology configuration between devices constituting the smart grid. Further, since a power producer can determine an electric power production status and an electric power usage status of the power consumer in real time through the defined network topology configuration, the power producer can flexibly adjust the electric power supply amount. In addition, it is possible to perform flexible management in which electricity is stored and thereafter, is supplied in a time zone in which power consumption is large and to prevent a failure of the smart grid caused due to an overload.

FIG. 6 is a flowchart for describing a process for a predetermined grid node in a grid network to select an alternative grid node when a neighboring power transmission target grid node loses its function. Herein, the predetermined grid node may be a root grid node or a relay grid node. It is assumed that a root grid node that receives electric power from a power transmitter is not fixed. In addition, it is assumed that a neighboring power transmission target grid node (hereinafter, referred to as a “neighboring power transmission target node”) of a predetermined grid node (grid node A) is false or loses its function while grid nodes belonging to a predetermined grid network transmit electric power on predetermined routes, respectively. In this case, whether or not the neighboring power transmission target node is false or loses its function may be determined based on a “Hello” message received from the neighboring power transmission target node to be described below.

Grid node A periodically broadcasts its positional information (alternately, physical distance information between nodes) and power distribution amount information (power consumption information of the power consumer) to neighboring grid nodes belonging to the same grid network (S400). In this case, the physical distance information between the nodes represents information on a physical distance between grid node A and each of the neighboring grid nodes.

In addition, grid node A receives positional information (alternately, physical distance information between the nodes) and power distribution amount information from the neighboring grid nodes belonging to the same grid network (S410). The above description is a neighbor discovery process implemented in the present invention.

Grid node A that receives the positional information and the power distribution amount information from the neighboring grid nodes compares the positional information and the power distribution amount information of the neighboring grid nodes with each other to allocate a priority to a neighboring grid node having a larger power distribution amount (S420). In this case, when a plurality of neighboring grid node having the same power distribution amount are provided, grid node A allocates the higher priority to a neighboring node having a short physical distance (S430). In addition, grid node A compares priority values allocated to the neighboring grid nodes with each other to select a neighboring grid node having the highest priority as the neighboring power transmission target node (S440).

When the neighboring power transmission target node is selected at step S440, grid node A configures a tree topology between the nodes by virtually blocking the transmission of electric power to neighboring grid nodes other than the selected power transmission target node (S450). The above description is a tree creation process implemented in the present invention.

When the tree topology is configured at step S450, grid node A stops periodically broadcasting its positional information and power distribution information to the neighboring grid nodes (S455) and periodically broadcast the “Hello” message (a status verification message) (S460).

In addition, grid node A determines whether or not the “Hello” message (alternately, Ack for the “Hello” message) is normally received from the neighboring power transmission target node selected at step S440 (S465).

According to the determination result at step S465, when the “Hello” message is normally received from the neighboring power transmission target node, grid node A proceeds to step S470 and otherwise, grid node A determines that the corresponding node is false or loses its function to proceed to step S400 and repetitively perform the above-mentioned process.

At step S470, grid node A determines whether or not its power distribution amount is changed.

According to the determination result at step S470, when its power distribution amount is changed, grid node A stops broadcasting the “Hello” message and proceeds to step S400 to repetitively perform the above-mentioned process. However, when its power distribution amount is not changed, grid node A proceeds to step S460 to periodically transmit the “Hello” message. The above description is a topology change detection process implemented in the present invention.

As described above, in a grid network according to an exemplary embodiment of the present invention, physical distance information between nodes and power distribution amount information are used as key parameters while retrieving a neighboring power transmission target node. In the present invention, when a hacker hacks a smart grid to distribute wrong power distribution information to the smart grid through the above configuration, an abnormal sign is detected by comparing the incorrect power distribution information with previously stored statistical data and when the abnormal sign is discovered, it is possible to prevent the illegal power distribution information from being distributed and prevent the security from being broken down due to hacking by virtually blocking an interface of the corresponding grid node.

As described above, the exemplary embodiments have been described and illustrated in the drawings and the description. Herein, specific terms have been used, but are just used for the purpose of describing the present invention and are not used for defining the meaning or limiting the scope of the present invention, which is disclosed in the appended claims. Therefore, it will be appreciated to those skilled in the art that various modifications are made and other equivalent embodiments are available. Accordingly, the actual technical protection scope of the present invention must be determined by the spirit of the appended claims.

What is claimed is:

1. A power distribution method, comprising:
receiving, by a predetermined grid node, power distribution amount information and physical distance information between grid nodes from neighboring grid nodes belonging to the same grid network;
allocating, by the predetermined grid node, priorities to the neighboring grid nodes by using the power distribution amount information and the physical distance information; and
selecting, by the predetermined grid node, a neighboring grid node having the highest priority as a neighboring power target transmission grid node by comparing the priorities allocated to the neighboring grid nodes.

2. The power distribution method according to claim 1, wherein the receiving power distribution amount information and physical distance information between grid nodes from neighboring grid nodes belonging to the same grid network is performed when a predetermined neighboring power transmission target grid node loses its function while the predetermined grid node transmits electric power to the predetermined neighboring power transmission target grid node depending on an initially set route.

3. The power distribution method according to claim 2, wherein the predetermined grid node determines whether or not the neighboring power transmission target grid node loses its function by using a status verification message received from the neighboring power transmission target grid node.

4. The power distribution method according to claim 1, wherein the allocating priorities to the neighboring grid nodes by using the power distribution amount information and the distance information allocates the higher priority to a grid node having the larger power distribution amount by comparing the power distribution amount information of the neighboring grid nodes with each other.

5. The power distribution method according to claim 4, wherein when a plurality of neighboring grid nodes have the same power distribution amount, the higher priority is allocated to a grid node which is closer to the predetermined grid node by comparing the physical distance information of the neighboring grid nodes with each other.

6. The power distribution method according to claim 1, further comprising blocking the transmission of electric power to other neighboring grid nodes other than the selected neighboring power transmission target grid node, when the neighboring power transmission target grid node is selected.

7. The power distribution method according to claim 1, wherein the predetermined grid node is a root grid node or a relay grid node.

8. The power distribution method according to claim 1, wherein the neighboring power transmission target grid node is any one of the relay grid node, a leaf grid node, and a hybrid grid node.

9. The power distribution method according to claim 8, wherein the hybrid grid node is connected with one or more power consumers that both produce and consume electric power.

10. A power distribution method, comprising:
receiving, by a root grid node belonging to a predetermined grid network, power generation amount information in a neighboring grid network from a root grid node of the neighboring grid network belonging to the same smart grid;
determining, by the root grid node belonging to the predetermined grid network, whether a neighboring gird network, having a larger power generation amount than that in the predetermined grid network, exists;
calculating, by the root grid node belonging to the predetermined grid network, a total power generation amount in the smart grid by using the power generation amount information received from the root grid node belonging to the neighboring grid network when the neighboring gird network having a larger power generation amount than that in the predetermined grid network does not exist; and
transmitting, by the root grid node belonging to a predetermined grid network, information on the total power generation amount to a generator.

11. The power distribution method according to claim 10, wherein the root grid node belonging to the predetermined grid network is connected with a root grid node belonging to each of a plurality of neighboring grid networks in a mesh structure to configure one smart grid.

12. The power distribution method according to claim 10, wherein the predetermined grid network includes a root grid node, a relay grid node, a leaf grid node, and a hybrid grid node, and
each of the grid nodes belonging to the predetermined grid network is connected with other grid nodes in the mesh structure.

13. The power distribution method according to claim 12, wherein the root grid node is directly connected with a power transmitter to distribute electricity supplied from the power transmitter to the relay grid node.

14. The power distribution method according to claim 12, wherein the hybrid grid node is connected with one or more power consumers that both produce and consume electric power and transmits information on a power production amount and information on power consumption of the power consumer to the relay grid node.

15. The power distribution method according to claim 14, wherein the relay grid node transmits the information on the power production amount and the information on the power consumption of the power consumer received from the hybrid grid node to the root grid node.

16. The power distribution method according to claim 12, wherein the relay grid node relays power distribution between the root grid node and the leaf grid node or relays power distribution between the root grid node and the hybrid grid node.

17. A power distribution apparatus, comprising:
a neighboring node information collection unit collecting power distribution amount information and physical distance information between grid nodes from neighboring grid nodes belonging to the same grid network; and
a power transmission target node selecting unit allocating priorities to the neighboring grid nodes by using the power distribution amount information and the physical distance information and selecting a neighboring grid node having the highest priority as a neighboring power transmission grid node by comparing the priorities allocated to the neighboring grid nodes.

18. The power distribution apparatus according to claim 17, wherein the power transmission target node selecting unit allocates the higher priority to a grid node having the larger power distribution amount by comparing the power distribution amount information of the neighboring grid nodes with each other and when a plurality of neighboring grid nodes have the same power distribution amount, allocates the higher priority to a grid node which is closer to the predetermined grid node by comparing the physical distance information of the neighboring grid nodes with each other.

19. The power distribution apparatus according to claim 17, further comprising, when the neighboring power transmission target grid node is selected by the power transmission target node selecting unit, a connection blocking unit blocking the transmission of electric power to other neighboring grid nodes other than the selected neighboring power transmission target grid node.

20. The power distribution apparatus according to claim 17, wherein the neighboring power transmission target grid node is any one of a relay grid node, a leaf grid node, and a hybrid grid node.
